(19) United States
(12) Patent Application Publication
(10) Pub. No.: US 2002/0179394 A1
(43) Pub. Date: Dec. 5, 2002

(54) Clutch of hub of bicycle

(76) Inventor: Chin-Fu Wu, Nan-Tou (TW)

Correspondence Address: Kuo-Hsiung Chiu, 13F, No.23, Jiun-Ho Street,, Peitun District, Taichung, 406, TW

(21) Appl. No.: 09/867,777

(22) Filed: May 31, 2001

(51) Int. Cl. F16D 41/24

(52) U.S. Cl. 192/64; 192/94

(57) ABSTRACT

It is an improvement of the clutch of the hub of the bicycle. The clutch is made up of the sleeve with attaching holes inside, the spiral connection part formed at the end of smaller diameter with the stair stepping tube, and the screw bar whose end of bigger diameter is the head part; the clutch crosses through the axle inside the hub and uses resisting component made up of the ball bearing that presses the spring to accommodate it in the connection hole of axle, or the leaf spring whose two ends are bent to be elastic clamp end in the distance existing between the axle and sleeve, to produce the clamp and directional function of point contact to the inner wall of sleeve; therefore, at the moment that the freewheel links the head part of screw bar to transmit the kinetic energy, it will not turn in the same direction with the screw bar and can respond to screw forward or backward instantly to decide whether it attaches to the inner wall of hub or not, thus to reduce the friction loss.

### BACKGROUND OF THE INVENTION

1. Field of the Invention

The present invention relates to the clutch of the hub of the bicycle using the sleeve which goes with the direction of the axle to decide continuous power transmittal or interruption into idling.

2. Description of the Prior Art

The new patent, “shift hub mechanism”, approved and numbered as 298164 by Taiwan (application no.85207413), is that it inserts a screw bar attached with a freewheel into one end of the inner axle rod of the hub, and the screw bar will be screwed and bitten with the inside-threaded sleeve at the other end; by applying force to the direction of the spring, when the pedal is stepped upon and driving the chain, the freewheel carries kinetic energy to the screw bar; the connected sleeve will turn axially forward or backward to attach or detach the inner wall of the hub, which decides either continuous power transmittal or interruption into idling.

Because the sleeve on the screw bar applies the principle of screwing forward axially and screwing backward in the opposite direction, which is the same with the measure of the bolt screwing the nut, i.e. “the revolving directions of the bolt and the nut are opposite to each other, so the screwing or unscrewing motion can be applied; if any part is not subject to force and the other part is turned solely, both will be turned in the same direction and unable to be turned forward or backward”; therefore, it uses the spring to apply the axial push force to the sleeve to make it screwed forward or backward by the screw bar; however, because “the spring cannot prevent the sleeve from turning in the same the direction with the screw bar”, at the initial instant, the shortcoming of unable to respond to screw forward or backward immediately happens easily.

The new patent, “clutch of hub of bicycle”, approved and numbered as 335518 by Taiwan (application no.86205033), is the same that it also inserts a screw bar attached with a freewheel into one end of the inner axle rod of the hub, and the screw bar will be screwed and bitten with the inside-threaded sleeve at the other end; the difference is that it clamps a C-shape sheet unto the outer diameter of the tube inserted between the axle rod and the bearing. This C-shape sheet directly goes through the inner diameter of the sleeve and it has bended rim which can be inlayed into the guiding part of the sleeve and therefore, it provides the sleeve with the directional force, which makes the sleeve not turning in the same direction with the screw bar, so that the sleeve will turn axially forward or backward to attach or detach the inner wall of the hub, which decides either continuous power transmittal or interruption into idling.

However, “the guiding part is easy to break or fracture due to improper riding and jump, etc.”, then the sleeve will turn in the same direction with the screw bar and cannot interrupt or continue the power transmittal because it loses the support of directional force.

### SUMMARY OF THE INVENTION

In consideration of the above-mentioned shortcomings, the inventor studied out a clutch of a hub that can produce clamp force to the sleeve. It uses the spring or leaf spring or any other elastic objects to provide radical elastic clamp force to the put-inside resisting component whose cross-section had better be round or circular arc, so as to restrict the sleeve from turning in the same direction with the screw bar, then to turn forward or backward to attach or detach the inner wall of the hub.

One of the inventing objectives is to provide a clutch that has the directional function by producing elastic clamp force in the radical direction.

One of the inventing objectives is to improve the area that may produce friction to the clutch inside the hub to be point contact, so as to reduce the loss during power transmittal.

### BRIEF DESCRIPTION OF THE DRAWINGS

FIG. 1: is the section plan of the clutch installed in the hub in the first practical example.

FIG. 2: is the cutaway view of the connection relationship between the sleeve, axle and leaf spring of the clutch in FIG. 1.

FIG. 3: is the exploded view of the clutch in the second practical example.

FIG. 4: is the section plan of the clutch installed in the hub in the second example.

FIG. 5: is the cutaway view of he connection relationship between the sleeve, axle and resisting component of the clutch in FIG. 4.

FIG. 6: is the close-up view of the clutch in FIG. 4.

### DETAILED DESCRIPTION OF THE PREFERRED EMBODIMENT

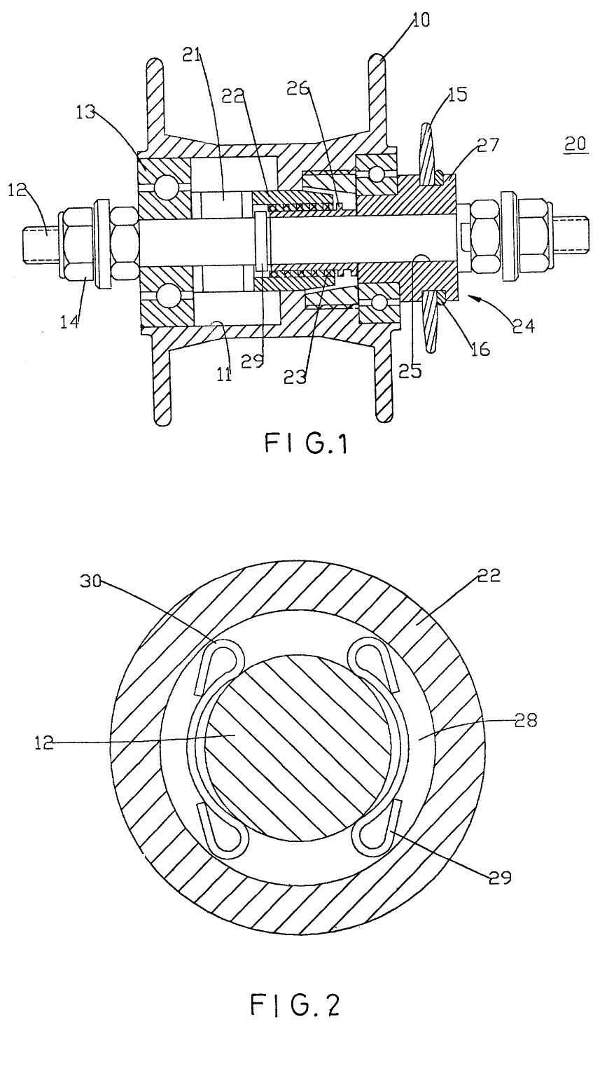

It can be seen in FIG. 1 of the practical example that hub 10 has fluctuant inner wall 11 because the hollow tube has different inside diameter, a axle 12 embedded in bearing 13 is fixed at one end of inner wall 11 by nut 14 and crosses through the other end; One or more collar 21 crosses through axle 12 and attach to the side of bearing 13 in inner wall 11 of hub 10, then sleeve 22 and hollow-tube screw bar 24 cross through axle 12 in succession, sleeve 22 is pushed into inner wall 11 to contact with collar 21, screw bar 24 embeds axle 13 on the other end of hub 10, it is locked with nut 14 again.

The above-mentioned screw bar 24 is a stair stepping tube, which has a linking hole 25 in the axes to get on axle 12; at the end of smaller diameter, the edge of the outside diameter inside hub 10 forms a spiral connection part 26 engaging with sleeve 22 with the single screw thread or double screw thread or multiple screw thread, the middle part embeds bearing 13; the end of biggest diameter provides head part 27 with freewheel 15 for the blocking and fixing cramp ring 16, inside sleeve 22, there is screw-thread attaching hole 23, which can interlock with spiral connection part 26 of screw bar 24 driven by freewheel 15, move along the direction of axes and make the outside diameter attach inner wall 11 of hub 10, so as to complete the primary members of clutch 20 inside hub 10.

It can be seen together with FIG. 2 that there is an annular distance space between sleeve 22 and axle 12, which can be called distance 28 and inside which it is enough to put one or more leaf spring 29, the two sides of the leaf spring 29 bend to similarly round or circular arc clamp end 30, every clamp end 30 contacts with inside diameter of sleeve 22 and outside diameter of axle 12 by point friction separately; therefore, it has the following advantages over the above common objects:

1. Sleeve 22 uses the clamp force applied by the point contact of leaf spring 29, which is enough to support the directional function rather than turn in the same direction with screw bar 24, therefore, it can take turning forward or backward motion at the moment that freewheel 15 transmits the kinetic energy.

2. When the clutch is used in a jumping bicycle or other functions, the stress passed by sleeve 22 will be absorbed by clamp end 30 of leaf spring 29, consequently, there is no possibility of fracture.

3. The coefficients of friction of point contact between clamp end 30 of leaf spring 29 and sleeve 22 and axle 12 are smaller than common objects; therefore, the loss will be reduced during power transmittal.

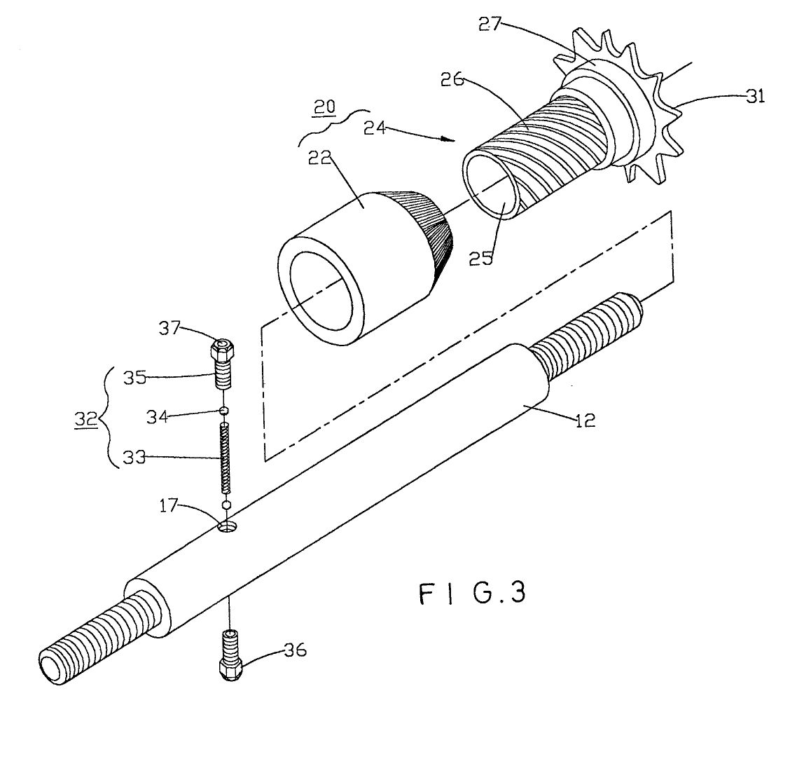

FIG. 3 shows the second practical example of clutch 20, which includes sleeve 22, screw bar 24 and resisting component 32. Among them, screw bar 24 is still a hollow tube, which crosses axle 12 through linking hole 25 on the axes, the outside diameter of the end close to sleeve 22 forms a attaching spiral connection part 26 by single screw thread or double screw thread or multiple screw thread; the other end is stair stepping head part 27, which forms continual fluted disc 31 at the edge by integrating molding technology to replace the existing blocking structure of the freewheel; resisting component 32 is made by spring 33 penetrating connection hole 17 that is put in axle 12, there are ball bearing 34 in the opening parts of the double ends, then it is locked by hollow coil 35.

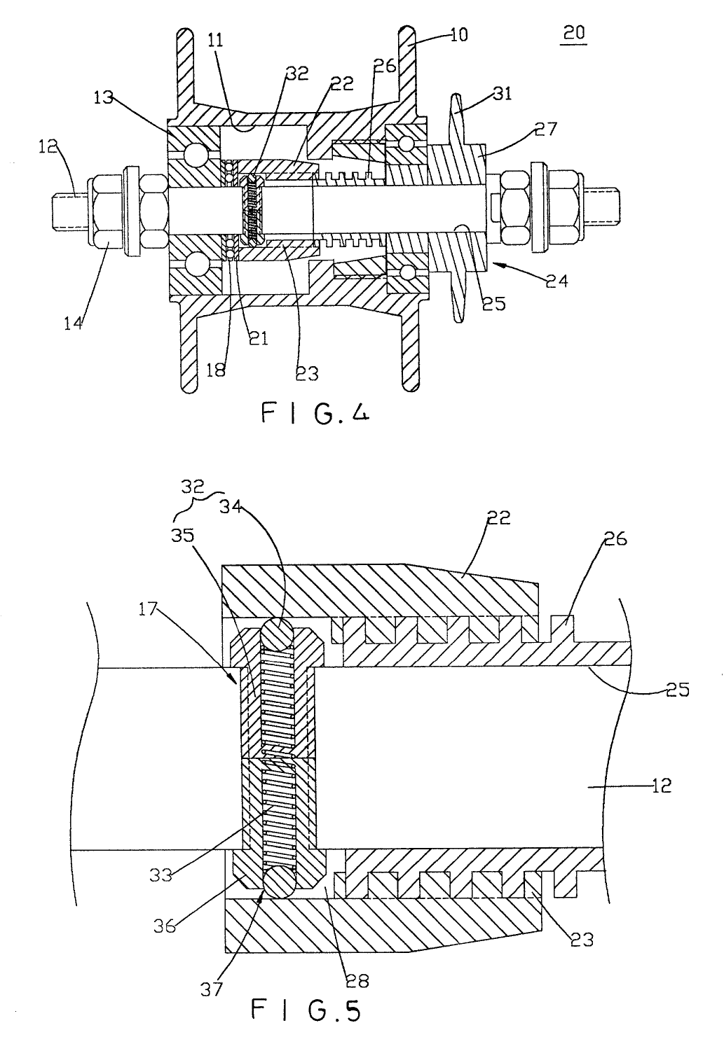

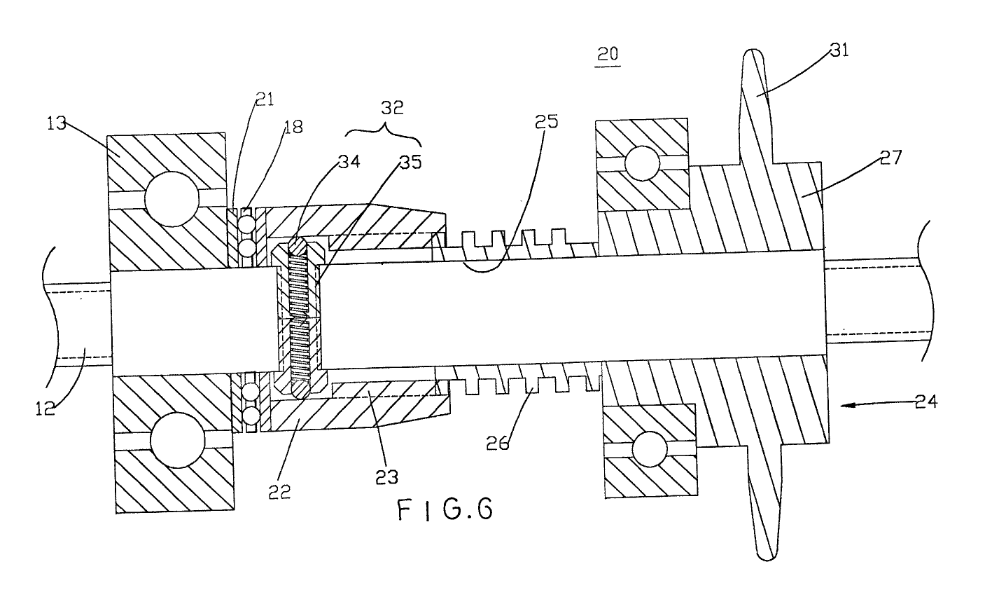

It can be known from the legends of FIGS. 4, 5 and 6 that axle 12 crosses through the inner wall 11 of hub 10, one end embeds bearing 13 and is fixed by nut 14, two collars 21 and ball plate 18 composing of multiple clamping steel balls cross through axle 12 and attack the side of inner wall 11 of bearing 13, sleeve 22 and screw bar 30 cross through axle 12 successively one by one to make sleeve 22 contact with collar 21 in inner wall 11, while screw bar 24 embeds another end of bearing 13 of hub 10 and is locked by nut 14. Since inside sleeve 22 there is screw-thread attaching hole 23, which can interlock with spiral connection part 26 of screw bar 24 driven by fluted disc 31, move along the direction of axes and make the outside diameter attach to inner wall 11 of hub 10.

It can be found out in FIG. 5 that axle 12 presets up connection hole 17 to assembly resisting component 32, which is exactly located in the existing range of distance 28 between sleeve 22 and axle 12, because the hole size pushed by the elastic force of spring 33 coil 35 used by ball bearing 34 is smaller than the diameter of ball bearing 34, ball hole 37 is formed; consequently, ball bearing 34 can only expose part of the ball so that it cannot bounce out, moreover, the exposed ball is only point contact with the inside diameter of sleeve 22, the coefficient of friction is rolling friction. It has the following advantages over the above common objects:

1. Sleeve 22 uses the clamp force executed by ball bearing 34 point contact, which is enough to support the directional function rather than turn in the same direction with screw bar 24; therefore, sleeve 22 can respond quickly to take turning forward or backward motions at the moment of kinetic energy transmittal.

2. When the clutch is used in a jumping bicycle or other functions, the stress passed by sleeve 22 will be absorbed by spring 33 after it is sent back by ball bearing 34; consequently, there is no possibility of fracture to unusable.

3. The friction between ball bearing 34 and sleeve 22 is rolling friction; therefore, the loss will be reduced to the minimum during power transmittal.

4. For the convenience of the locking steps between coil 35 and connection hole 17, the edge located in the end of ball hole 37 can form multilateral spiral lock end 36.

5. Besides reducing the stroke of sleeve 22 turning forward or backward to accelerate the time effect of attaching inner wall 11 of hub 10, the designing of collar 21 even uses ball plate 18 made of clamp steel balls to reduce friction resistance.

To sum up, this invention uses the elastic force or provides a radical elastic clamp force to the resisting component put inside the sleeve to restrict the sleeve from turning in the same direction with the screw bar, so as to accelerate the turning forward or backward for attaching and detaching. It is really a perfect improvement of the clutch of the existing hub; please approve the patent!

What is claimed is:

1. An improvement of the clutch of the hub of the bicycle, includes: sleeve, attaching hole inside the sleeve; screw bar, is stair stepping tube and has linking hole in the axle, the edge of the end of smaller diameter can form a spiral connection part connected with the attaching hole by single or multiple screw thread, the end of bigger diameter is the head part to connect the freewheel;
The clutch made of the above screw bar and sleeve, crosses in the axle located inside the hub and uses the freewheel to transmit the kinetic energy to rotate the screw bar, so as to drive the sleeve to move forward or backward axially on the screw bar, thus to decide whether it attaches the inner wall of hub: The primary characteristics lie in: there is a penetrative connection hole in the distance between the axle and sleeve corresponding to the range of the axial movement of the sleeve for the ball bearing to press the spring to make up a kind of resisting component; it uses the clamp and directional function of point contact produced by the ball bearing to the sleeve to make it not turn in the same direction with the screw bar and respond to screw forward or backward at the moment of power transmittal, so that the friction loss is reduced.

2. According to the improvement of the clutch of the hub of the bicycle mentioned in the first item of the patent application scope, the resisting component can have a hollow coil connected with the connection hole for the above ball bearing to press the spring so as to be assembled in the tube; moreover, the diameter of a tube of at least one end should be smaller than the diameter of the ball bearing to form the ball hole, so that part of the ball exposes to keep point contact with the inside of the sleeve but cannot bounce out.

3. According to the improvement of the clutch of the hub of the bicycle mentioned in the second item of the patent application range, the edge of coil close to the end of the ball hole can form multilateral spiral lock ends for the convenience of the locking steps.

4. According to the improvement of the clutch of the hub of the bicycle mentioned in the first item of the patent application scope, the resisting component can be replaced by the leaf spring; two sides of which have been bent to the elastic clamp end, and assembled in the distance existing between the sleeve and the axle, the clamp end produces directional function for the sleeve.

5. According to the improvement of clutch of hub of bicycle mentioned in the first item or the fourth item of the patent application range, the axle can add one or more collar in the forward or backward range in the axial direction of the sleeve, so as to shorten the stroke to accelerate the attaching time effect.

6. According to the improvement of the clutch of the hub of the bicycle mentioned in the first item or the fourth item of the patent application scope, that the axle adds one or more ball plates made of multiple clamp steel balls in the forward or backward scope of in the axial direction of the sleeve, can not only shorten the stroke to accelerate the attaching time effect, but also reduce the friction resistance.

7. According to the improvement of the clutch of the hub of the bicycle mentioned in the first item or the fourth item of the patent application scope, the head part of the screw bar can be molded integrally with the fluted disc to replace the existing freewheel.
